(19) United States
(12) Patent Application Publication
(10) Pub. No.: US 2005/0157041 A1
(43) Pub. Date: Jul. 21, 2005

(54) Inkjet recording apparatus

(75) Inventor: Hiroshi Inoue, Ashigara-Kami-Gun (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/036,374

(22) Filed: Jan. 18, 2005

(30) Foreign Application Priority Data
Jan. 19, 2004 (JP) 2004-10293

(51) Int. Cl. B41J 2/145; B41J 2/15

(52) U.S. Cl. 347/40

(57) ABSTRACT

The inkjet recording apparatus which forms an image on a recording medium comprises an ink discharge head which discharges droplets of ink onto the recording medium, and a pressure varying device which controls an internal pressure of the ink discharge head according to a plurality of set values associated with a plurality of usage conditions for the ink discharge head.

### BACKGROUND OF THE INVENTION

1. Field of the Invention

The present invention relates to an inkjet recording apparatus, and more specifically to an inkjet recording apparatus wherein a sub-tank is placed between an ink bottle (main ink tank) and an inkjet head, and the internal pressure of the head is controlled by the sub-tank.

2. Description of the Related Art

As an example of an image recording apparatus, an inkjet recording apparatus that has an inkjet head (ink discharge head) arranged with an array of multiple nozzles is known. The inkjet recording apparatus forms an image on a recording medium by discharging ink from the nozzles while the inkjet head and the recording medium are moved relatively.

Conventionally, various methods of discharging the ink for such an inkjet recording apparatus are known. For example, the inkjet recording apparatus is known as a method of a piezoelectric system in which an oscillating plate constituting part of a pressure chamber (ink chamber) is deformed by the deformation of a piezoelectric element (piezoelectric ceramics) to vary the capacity of the pressure chamber, ink is introduced into the pressure chamber through an ink supply channel during the capacity increase of the pressure chamber, and the ink in the pressure chamber is discharged as droplets from a nozzle when the capacity of the pressure chamber decreases. Moreover, the inkjet recording apparatus is also known as a method of a thermal inkjet system in which the ink is heated to create air bubbles and is discharged by the energy of expansion when the air bubbles increase in size.

According to the image recording apparatuses having an inkjet head (hereinafter referred to as ink discharge head) such as inkjet recording apparatuses, ink is supplied from an ink tank for storing ink to an ink discharge head via an ink supply channel, and then the ink is discharged by the various discharge methods described above. However, the inkjet recording apparatuses have negative effects in that if an attempt is made to supply the ink to the ink discharge head by suddenly suctioning up the ink from the ink tank when the ink is supplied from the ink tank to the ink discharge head, the ink cannot be sufficiently supplied to the ink discharge head due to large flow duct resistance.

Conventionally, an ink sub-tank is provided as a buffer between the ink tank and the ink discharge head. Since the ink is supplied from the sub-tank to the ink discharge head, the ink discharge head is attempted to the stabilization of ink supply, the improvement for refilling ink, and the like. However, when the sub-tank is opened to the atmosphere, there is a problem to encounter in that the effects of the deaerated ink decrease with time because the sub-tank is open to the atmosphere even if deaerated ink is used to maintain ink discharge stability.

In order to resolve the problem, for conventional example, Japanese Patent Application Publication No. 2000-141687 discloses a sub-ink pouch is sealed by removing the ink inlet and ink outlet as the sub-tank, and the sub-ink pouch is covered by a case that is sealed by removing the external connecting part. When the internal pressure in the sealed space between the sub-ink pouch and the case is adjusted, the ink is introduced into the sub-ink pouch from the ink tank by reducing the pressure in the sealed space, and then ink is filled forcibly into an ink discharge head from the sub-ink pouch while increasing the pressure in the sealed space.

However, in Japanese Patent Application Publication No. 2000-141687, while the ink is supply to the sub-ink pouch from the ink tank by reducing the pressure in the sealed space between the sub-ink pouch and the case covering the pouch with a pump, the ink is only supplied forcibly from the sub-ink pouch to the ink discharge head by increasing the pressure in the sealed space with a pump. Therefore, the pressure in the sealed space is not controlled in response to the various states of the ink discharge head.

Similarly, the recording head has various states of use. For example, the recording head has various states other than normal printing state such as preliminary discharge (purging), air bubble emission, fast loading, non-discharge determination, recording paper jamming, power off, standby, and the like. Therefore, there is a demand for the ability to control the ink discharge head for maintaining the optimal state of the ink discharge head.

However, including Japanese Patent Application Publication No. 2000-141687, there are no examples in conventional practice wherein the internal pressure of the ink discharge head is optimally controlled by a sub-tank according to the state of the ink discharge head.

### SUMMARY OF THE INVENTION

The present invention has been contrived in view of such circumstances, and an object thereof is to provide an inkjet recording apparatus that the ink is discharged in a stable manner such as the improvement of refilling process, the miniaturization of suction device, and the decrease of wasted ink by controlling the internal pressure of the ink discharge head according to the various usage conditions of the ink discharge head.

In order to attain the aforementioned object, the present invention is directed to an inkjet recording apparatus which forms an image on a recording medium, comprising: an ink discharge head which discharges droplets of ink onto the recording medium: and a pressure varying device which controls an internal pressure of the ink discharge head according to a plurality of set values associated with a plurality of usage conditions for the ink discharge head.

According to the present invention, a stabilization of ink discharge and an improvement of refilling process can be achieved by controlling the internal pressure of the ink discharge head so as to maintain the optimal pressure for various conditions.

Furthermore, it is preferable that the inkjet recording apparatus further comprises a pressure measuring device which measures the internal pressure of the ink discharge head.

In order to attain the aforementioned object, the present invention is directed to an inkjet recording apparatus which forms an image on a recording medium, comprising: an ink discharge head which discharges droplets of ink onto the recording medium; and a pressure varying device which controls an internal pressure of the ink discharge head according to set values associated with at least two of the following usage conditions, (1) a printing condition; (2) at least one of a preliminary discharge condition and an ink suction condition; and (3) at least one of a non-discharge determination condition, a power off condition, and a standby condition.

According to the present invention, the usage conditions of the ink discharge head include the three types of the usage conditions: (1) a printing condition; (2) at least one of a preliminary discharge condition and an ink suction condition; and (3) at least one of a non-discharge determination condition, a power off condition, and a standby condition. In at least two of the three different usage conditions, since the extremely precise internal pressure is controlled by varying the control target value of the internal pressure, it is possible to achieve stability during ink discharge.

In addition, it is preferable that the inkjet recording apparatus further comprises a pressure measuring device which measures the internal pressure of the ink discharge head.

More specifically, it is preferable that the pressure varying device controls the internal pressure of the ink discharge head during the at least one of the preliminary discharge condition and the ink suction condition so as to be higher pressure than the internal pressure of the ink discharge head during the printing condition. Therefore, it is possible to expel highly viscous ink or ink containing admixed air bubbles with a small amount of energy, and it is possible to reduce the size of the suction apparatus and the amount of wasted ink.

Furthermore, it is preferable that the pressure varying device controls the internal pressure of the ink discharge head during the at least one of the non-discharge determination condition, the power off condition, and the standby condition so as to be lower pressure than the internal pressure of the ink discharge head during the printing condition. In this case, while it is possible to prevent ink from leaking from the nozzles, the ink discharge failures can be determined under stricter ink discharge conditions. Therefore it is possible to ensure a margin of stability.

According to anther aspect of present invention, it is preferable that the inkjet recording apparatus further comprises an ink tank which supplies the ink to the ink discharge head; an ink supply channel which connects the ink tank with the ink discharge head; and a sub-tank which is provided to the ink supply channel, wherein the pressure varying device controls an internal pressure of the sub-tank so as to control the internal pressure of the ink discharge head. Therefore, since there is particularly no need to install a pump or the like for controlling the internal pressure, it is possible to reduce those equipment costs.

In accordance with the present invention described above, the inkjet recording apparatus controls the internal pressure according to the usage conditions of the ink discharge head. Therefore, it is possible to ensure a stabilization of ink discharge and an improvement of refilling process and extend the maintenance cycle (reduce maintenance frequency).

In addition, when the internal pressure is higher during preliminary discharge or suction than during printing, it is possible to reduce the size of the suction apparatus and the amount of wasted ink. At the same time, when the internal pressure is lower during non-discharge determination or the like than during printing, it is possible to prevent ink from leaking from the nozzles and determine ink discharge failures under stricter conditions. Therefore, it is possible to ensure a higher margin of stability for ink discharge.

### BRIEF DESCRIPTION OF THE DRAWINGS

The nature of this invention, as well as other objects and advantages thereof, will be explained in the following with reference to the accompanying drawings, in which like reference characters designate the sane or similar parts throughout the figures and wherein:

FIG. 1 is a general schematic drawing of an inkjet recording apparatus according to an embodiment of the present invention;

FIG. 2 is a cross-sectional partial view of a print head in the inkjet recording apparatus of the embodiment;

FIG. 3 is a general schematic drawing of the ink supply system in the inkjet recording apparatus according to the embodiment;

FIG. 4 is a general schematic drawing of the ink supply system in the inkjet recording apparatus according to another embodiment of the present invention; and

FIG. 5 is a general schematic drawing of the ink supply system in the inkjet recording apparatus according to the yet another embodiment of the present invention.

### DETAILED DESCRIPTION OF THE PREFERRED EMBODIMENTS

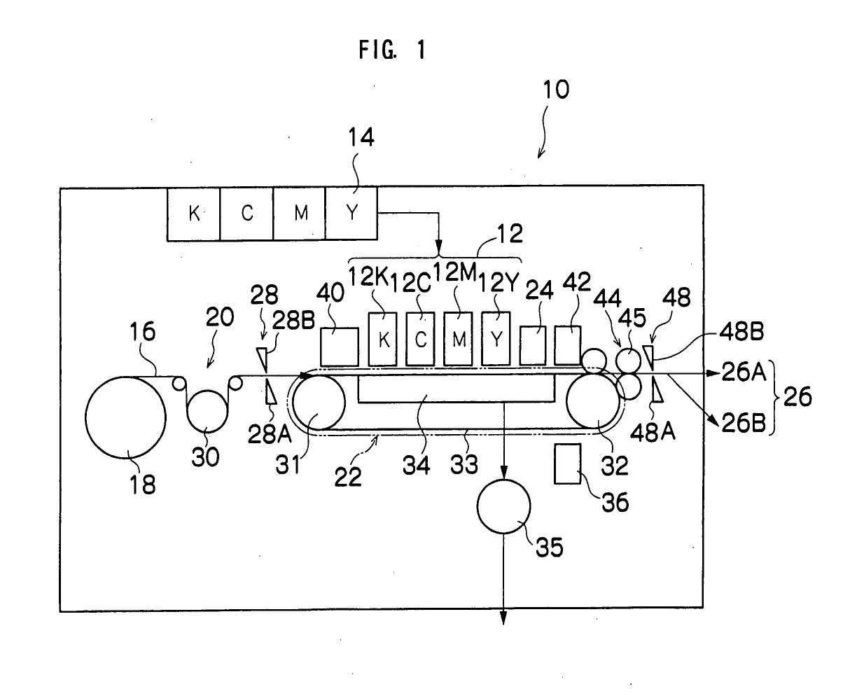

FIG. 1 is a general schematic drawing of an inkjet recording apparatus according to an embodiment of the present invention. As shown in FIG. 1, the inkjet recording apparatus 10 comprises: a printing unit 12 having a plurality of print heads (droplet discharge heads) 12K, 12C, 12M, and 12Y for ink colors of black (K), cyan (C), magenta (M), and yellow (Y), respectively; an ink storing/loading unit 14 for storing inks to be supplied to the print heads 12K, 12C, 12M, and 12Y; a paper supply unit 18 for supplying recording paper 16; a decurling unit 20 for removing curl in the recording paper 16; a suction belt conveyance unit 22 disposed facing the nozzle face (ink-droplet ejection face) of the print unit 12, for conveying the recording paper 16 while keeping the recording paper 16 flat; a print determination unit 24 for reading the printed result produced by the printing unit 12; and a paper output unit 26 for outputting image-printed recording paper (printed matter) to the exterior.

In FIG. 1, a single magazine for rolled paper (continuous paper) is shown as an example of the paper supply unit 18; however, a plurality of magazines with paper differences such as paper width and quality may be jointly provided. Moreover, paper may be supplied with a cassette that contains cut paper loaded in layers and that is used jointly or in lieu of a magazine for rolled paper.

In the case of the configuration in which roll paper is used, a cutter (first cutter) 28 is provided as shown in FIG. 1, and the continuous paper is cut into a desired size by the cutter 28. The cutter 28 has a stationary blade 28A, whose length is equal to or higher than the width of the conveyor pathway of the recording paper 16, and a round blade 28B, which moves along the stationary blade 28A. The stationary blade 28A is disposed on the reverse side of the printed surface of the recording paper 16, and the round blade 28B is disposed on the printed surface side across the conveyor pathway. When cut paper is used, the cutter 28 is not required.

In the case of a configuration in which a plurality of types of recording paper can be used, it is preferable that an information recording medium such as a bar code and a wireless tag containing information about the type of paper is attached to the magazine, and by reading the information contained in the information recording medium with a predetermined reading device, the type of paper to be used is automatically determined, and ink-droplet ejection is controlled so that the ink-droplets are ejected in an appropriate manner in accordance with the type of paper.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. The heating temperature at this time is preferably controlled so that the recording paper 16 has a curl in which the surface on which the print is to be made is slightly round outward.

The decurled and cut recording paper 16 is delivered to the suction belt conveyance unit 22. The suction belt conveyance unit 22 has a configuration in which an endless belt 33 is set around rollers 31 and 32 so that the portion of the endless belt 33 facing at least the nozzle face of the printing unit 12 and the sensor face of the print determination unit 24 forms a horizontal plane (flat plane).

The belt 33 has a width that is higher than the width of the recording paper 16, and a plurality of suction apertures (not shown) are formed on the belt surface. A suction chamber 34 is disposed in a position facing the sensor surface of the print determination unit 24 and the nozzle surface of the printing unit 12 on the interior side of the belt 33, which is set around the rollers 31 and 32, as shown in FIG. 1. The suction chamber 34 provides suction with a fan 35 to generate a negative pressure, and the recording paper 16 is held on the belt 33 by suction.

The belt 33 is driven in the clockwise direction in FIG. 1 by the motive force of a motor (not shown) being transmitted to at least one of the rollers 31 and 32, which the belt 33 is set around, and the recording paper 16 held on the belt 33 is conveyed from left to right in FIG. 1.

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not depicted, examples thereof include a configuration in which the belt 33 is nipped with a cleaning roller such as a brush roller and a water absorbent roller, an air blow configuration in which clean air is blown onto the belt 33, or a combination of these. In the case of the configuration in which the belt 33 is nipped with the cleaning roller, it is preferable to make the line velocity of the cleaning roller different than that of the belt 33 to improve the cleaning effect.

The inkjet recording apparatus 10 can comprise a roller nip conveyance mechanism, in which the recording paper 16 is pinched and conveyed with nip rollers, instead of the suction belt conveyance unit 22. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 40 is disposed on the upstream side of the printing unit 12 in the conveyance pathway formed by the suction belt conveyance unit 22. The heating fan 40 blows heated air onto the recording paper 16 to heat the recording paper 16 immediately before printing so that the ink deposited on the recording paper 16 dries more easily.

The printing unit 12 forms a so-called full-line head in which a line head having a length that corresponds to the maximum paper width is disposed in the main scanning direction perpendicular to the delivering direction of the recording paper 16. Each of the print heads 12K, 12C, 12M, and 12Y is composed of a line head, in which a plurality of ink-droplet ejection apertures (nozzles) are arranged along a length that exceeds at least one side of the maximum-size recording paper 16 intended for use in the inkjet recording apparatus 10.

The print heads 12K, 12C, 12M, and 12Y are arranged in this order from the upstream side (the left-hand side in FIG. 1) along the delivering direction of the recording paper 16 (hereinafter referred to as the paper conveyance direction). A color print can be formed on the recording paper 16 by ejecting the inks from the print heads 12K, 12C, 12M, and 12Y, respectively, onto the recording paper 16 while conveying the recording paper 16.

Although the configuration with the KCMY four standard colors is described in the present embodiment, combinations of the ink colors and the number of colors are not limited to those, and light and/or dark inks can be added as required. For example, a configuration is possible in which print heads for ejecting light-colored inks such as light cyan and light magenta are added. Moreover, a configuration is possible in which a single print head adapted to record an image in the colors of CMY or KCMY is used instead of the plurality of print heads for the respective colors.

The print unit 12, in which the full-line heads covering the entire width of the paper are thus provided for the respective ink colors, can record an image over the entire surface of the recording paper 16 by performing the action of moving the recording paper 16 and the print unit 12 relatively to each other in the sub-scanning direction just once (i.e., with a single sub-scan). Higher-speed printing is thereby made possible and productivity can be improved in comparison with a shuttle type head configuration in which a print head reciprocates in the main scanning direction.

As shown in FIG. 1, the ink storing/loading unit 14 has tanks for storing the inks to be supplied to the print heads 12K, 12C, 12M, and 12Y, and the tanks are connected to the print heads 12K, 12C, 12M, and 12Y through channels (not shown), respectively. The ink storing/loading unit 14 has a warning device (e.g., a display device, an alarm sound generator) for warning when the remaining amount of any ink is low, and has a mechanism for preventing loading errors among the colors.

The print determination unit 24 has an image sensor for capturing an image of the ink-droplet deposition result of the print unit 12, and functions as a device to check for ejection defects such as clogs of the nozzles in the print unit 12 from the ink-droplet deposition results evaluated by the image sensor.

The print determination unit 24 of the present embodiment is configured with at least a line sensor having rows of photoelectric transducing elements with a width that is higher than the ink-droplet ejection width (image recording width) of the print heads 12K, 12C, 12M, and 12Y. This line sensor has a color separation line CCD sensor including a red (R) sensor row composed of photoelectric transducing elements (pixels) arranged in a line provided with an R filter, a green (G) sensor row with a G filter, and a blue (B) sensor row with a B filter. Instead of a line sensor, it is possible to use an area sensor composed of photoelectric transducing elements which are arranged two-dimensionally.

The print determination unit 24 reads a test pattern printed with the print heads 12K, 12C, 12M, and 12Y for the respective colors, and the ejection of each head is determined. The ejection determination includes the presence of the ejection, measurement of the dot size, and measurement of the dot deposition position.

A post-drying unit 42 is disposed following the print determination unit 24. The post-drying unit 42 is a device to dry the printed image surface, and includes a heating fan, for example. It is preferable to avoid contact with the printed surface until the printed ink dries, and a device that blows heated air onto the printed surface is preferable.

In cases in which printing is performed with dye-based ink on porous paper, blocking the pores of the paper by the application of pressure prevents the ink from coming contact with ozone and other substance that cause dye molecules to break down, and has the effect of increasing the durability of the print.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathway in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. The cutter 48 is disposed directly in front of the paper output unit 26, and is used for cutting the test print portion from the target print portion when a test print has been performed in the blank portion of the target print. The structure of the cutter 48 is the same as the first cutter 28 described above, and has a stationary blade 48A and a round blade 48B.

Although not shown in FIG. 1, a sorter for collecting prints according to print orders is provided to the paper output unit 26A for the target prints.

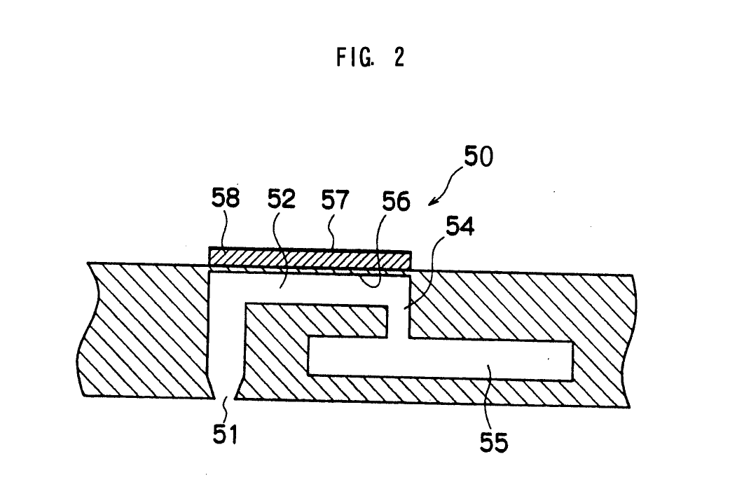

Next, the structure of the droplet discharge heads or the print heads is described. The print heads 12K, 12C, 12M, and 12Y provided for the respective ink colors have the same structure, and a reference numeral 50 is hereinafter designated to any of the print heads 12K, 12C, 12M, and 12Y FIG. 2 is a perspective plan view showing an example of the configuration of the print head 50.

As shown in FIG. 2, the print head 50 in the present embodiment is comprised a nozzle 51 for ejecting ink-droplets, and a pressure chamber 52 connecting to the nozzles 51 for giving pressure to ejected ink. The planar shape of the pressure chamber 52 provided for each nozzle 51 is substantially a square, and the nozzle 51 and a supply port 54 are disposed in both corners on a diagonal line of the square. The pressure chamber 52 is connected to a common channel 55 through the supply port 54.

A piezoelectric element (an actuator) 58 having a discrete electrode 57 is joined to a vibration plate (a pressure plate) 56, which forms a face of the pressure chamber 52 (the ceiling in FIG. 2). The piezoelectric element 58 is deformed by applying drive voltage to the discrete electrode 57, and the volume of the pressure chamber 52 is reduced so as to eject ink from the nozzle 51. When ink is ejected, the volume of the pressure chamber 52 is recovered, and then new ink is delivered from the common channel 55 through the supply port 54 to the pressure chamber 52.

Next, the ink supply system of the inkjet recording apparatus for controlling the internal pressure of the print head by means of a sub-tank, which is a characterized by the present invention, will be described in detail.

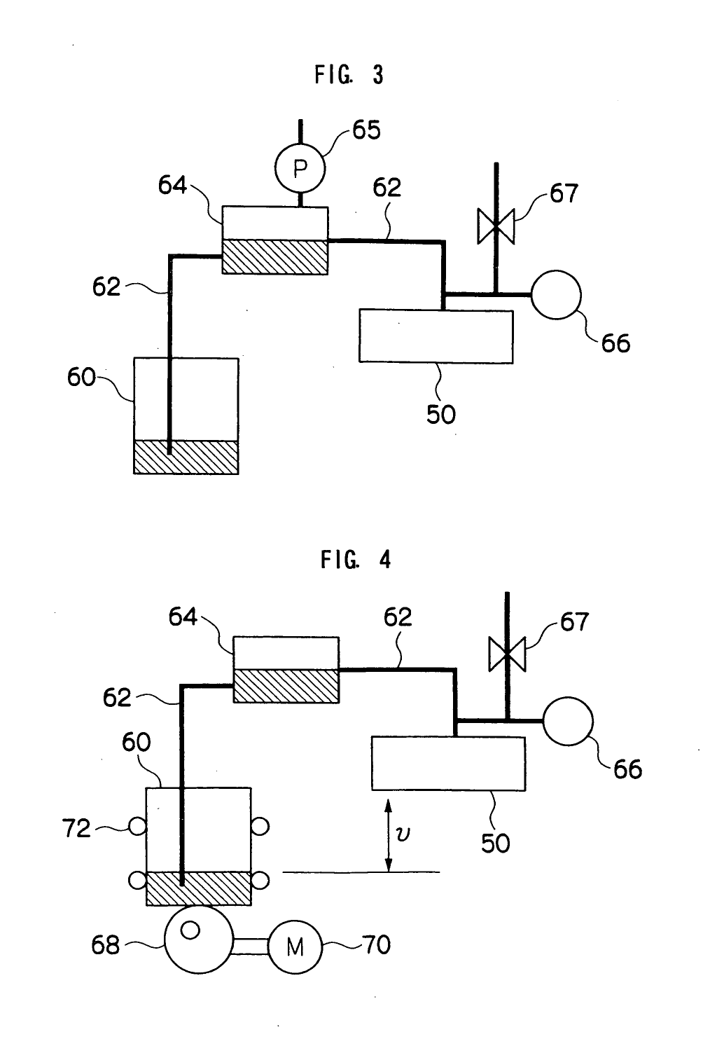

FIG. 3 is a general schematic drawing of the ink supply system in the inkjet recording apparatus 10 according to the embodiment of the present invention. In FIG. 3, an ink supply tank (ink tank) 60 is a basic tank for supplying ink to the print head 50 and is set in the ink storing/loading unit 14 described with reference to FIG. 1. The aspects of the ink supply tank 60 include a refillable type and a cartridge type: when the remaining amount of ink is low, the ink supply tank 60 of the refillable type is filled with ink through a filling port (not shown) and the ink supply tank 60 of the cartridge type is replaced with a new one. In order to change the ink type in accordance with the intended application, the cartridge type is suitable, and it is preferable to represent the ink type information with a bar code or the like on the cartridge, and to perform ejection control in accordance with the ink type.

As shown in FIG. 3, a sub-tank 64 is provided as a buffer in an ink supply channel 62 for supplying ink to the print head 50 from the ink supply tank 60. In the present invention, it is possible to stabilize the ink-discharging by controlling the internal pressure of the print head 50 in accordance with the usage conditions of the print head 50. In the present embodiment, the internal pressure of the print head 50 is controlled by controlling the internal pressure of the sub-tank 64.

In other words, the sub-tank 64 has a function as pressure varying device for varying the internal pressure of the print head 50. In the present embodiment, a pump 65 connected to the sub-tank 64 is provided for varying the internal pressure of the sub-tank 64. In this case, the internal pressure decreases when the air in the sub-tank 64 is suctioned out by the pump 65. At the same time, the internal pressure increases when air is added into the sub-tank 64 by the pump 65.

In addition, the ink supply channel 62 between the sub-tank 64 and the print head 50 is provided with a pressure gauge 66 as a pressure measuring device for measuring the internal pressure of the print head 50, and an atmosphere venting valve 67 is provided between the pressure gauge 66 and the ink supply channel 62.

Referring to following, a method for controlling the internal pressure of the print head 50 by controlling the internal pressure of the sub-tank 64 according to the usage conditions of the print head 50 is described as a function of the present embodiment.

First, the internal pressure of the sub-tank 64 is kept to be constant so that the internal pressure of the print head 50 remains at the same level during printing. At this time, the internal pressure of the print head 50 is measured by the pressure gauge 66, and it is preferable that the internal pressure of the print head 50 is controlled so as to be at the target negative pressure value of −1.5 kPa, for example.

In this case, since the internal pressure of the print head 50 is controlled so as to maintain a constant pressure, it is possible to prevent ink supply defects in cases in which highly viscous ink is used, the ink becomes highly viscous, or continuous discharge is performed. Also, since the ink can be discharged in a stable manner by maintaining a constant internal pressure in the print head 50, a stable concentration can be ensured in the ink discharged onto a recording medium.

Next, during preliminary discharge (purging), air bubble expulsion (ink suction), or initial ink filling, the internal pressure of the sub-tank 64 is controlled by the pump 65 so that the internal pressure of the print head 50 reaches a value higher than during printing. In other words, the negative pressure applied to the ink is controlled so as to be lower than during printing. At this time, the internal pressure of the print head 50 is measured by the pressure gauge 66, and it is preferable that the internal pressure of the print head 50 is controlled to be at the target negative pressure value of −0.5 kPa, for example.

In this case, since the negative pressure acting on the ink is decreased to lower than during printing, a higher pressure is applied to the ink than during printing. Therefore, ink with an increased viscosity can be discharged outside of the apparatus with a small amount of energy.

The target value described above is one example, and any value at least higher than during printing (a small negative pressure value) is acceptable. For example, there is no need to use the same target value during preliminary discharge and air bubble expulsion (ink suction).

Next, during non-discharge determination, power off, uncapping, or standby, the internal pressure of the sub-tank 64 is controlled by the pump 65 so that the internal pressure of the print head 50 is lower than during printing. In other words, the negative pressure applied to the ink is controlled so as to be higher than during printing. At this time, the internal pressure of the print head 50 is measured by the pressure gauge 66, and it is preferable that the internal pressure of the print head 50 is controlled to be at the target negative pressure value of −2.5 kPa, for example.

In this case, since the internal pressure of the print head 50 is decreased to lower than during printing, a higher amount of energy is required for ink discharge than during printing, and during preliminary discharge. Therefore, the discharge can be checked under stricter conditions and the reliability of the nozzle can be improved. At the same time, since the negative pressure is increased, ink can be prevented from leaking from the nozzle during power off, uncapping, standby, or the like, even during atmospheric pressure fluctuations or temperature fluctuations.

Furthermore, the target value presented above is one example, and any value at least higher than during printing (a small negative pressure value) is acceptable. For example, there is no need to use the same target value (for example, −2.5 kPa) during non-discharge determination, power off, uncapping, or standby.

When the recording paper is jammed directly underneath the print head 50, the recording paper comes in contact with the nozzle. Therefore, there is a possibility that the meniscus surface of the ink sometimes ruptures and the ink leaks out. In order to avoid this situation, the ink must be prevented from leaking out of the nozzle by applying a sufficiently large negative pressure to the ink.

In this case, the negative pressure is sufficiently increased to be higher than during printing when the paper is jammed directly underneath the print head. For example, a target negative pressure value of about −10 kPa is preferred. In this manner, the ink can be prevented from leaking out of the nozzle by applying higher negative pressure.

At this time, since all the ink sometimes runs out of the nozzle and the head itself due to considerable negative pressure, the process must progress to the initial ink filling mode, and the ink must be forced into the print head 50 during a return.

As described above, in the present embodiment, there are a plurality of target control values for the internal pressure of the print head 50, and the target values are varied according to the usage conditions of the print head 50 to control the internal pressure. Therefore, while a stable ink discharge can be achieved, and the maintenance cycle can be extended (maintenance frequency reduced) by ensuring the improvements in the refilling process.

Also, since the internal pressure of the print head 50 is increased during preliminary discharge or air bubble expulsion to be higher than during printing, ink can be discharged with a smaller amount of energy. Therefore, while the size of the suction apparatus can be reduced, the amount of wasted ink can be reduced.

Furthermore, since the internal pressure during non-discharge determination and the like is decreased to be lower than during printing increases the energy needed for ink discharge, a stable margin for ink discharge can be ensured by checking the discharge under stricter conditions.

The method for controlling the internal pressure of the sub-tank is not limited to increasing and suctioning out the pressure in the sub-tank with a pump as described above, and other methods may be used. In view of this, other embodiments of the present invention will now be described.

FIG. 4 is a general schematic drawing of the ink supply system in the inkjet recording apparatus according to another embodiment of the present invention. The ink supply system in FIG. 4 controls the internal pressure of the sub-tank for controlling the internal pressure of the print head 50 by changing the liquid level difference between the ink tank and the print head (liquid pressure applied to the ink).

As shown in FIG. 4, a pump is not installed in the sub-tank 64 in this embodiment, but instead the ink tank 60 is moved up and down by an eccentric cam 68 driven by a motor 70 to change the liquid level difference v between the print head 50 and the ink tank 60, whereby the internal pressure of the sub-tank 64 is varied.

The ink tank 60 has a cylindrical shape for example, and a roller 72 is provided around the ink tank 60 for moving up and down the ink tank 60 easily and reliably. Also, in the same way as in the above embodiment, a pressure gauge 66 for measuring the internal ink pressure of the print head 50 and an atmosphere venting valve 67 for resetting the internal pressure to atmospheric pressure are provided to the ink supply channel 62 near the print head 50.

In this case, the internal ink pressure may also be controlled by controlling the height of the liquid surfaces in the print head 50 and the ink tank 60 without the use of a pressure gauge 66.

In this embodiment, according to the usage conditions of the print head 50 on the basis of the internal pressure value of the print head 50 as measured by the pressure gauge 66, the ink tank 60 is moved up and down and the internal pressure of the sub-tank 64 is controlled.

The method of controlling is specifically the same as in the previous embodiment. In other words, the internal pressure of the sub-tank 64 is first controlled to be constant so that the internal pressure of the print head 50 remains at the same level during printing. At this time, it is preferable that the target negative pressure value for internal pressure control be set to −1.5 kPa for example, similar to the previous example.

Next, during preliminary discharge (purging), air bubble expulsion (ink suction), or initial ink filling, the internal pressure of the sub-tank 64 is controlled so that the internal pressure of the print head 50 reaches a value higher than during printing. In other words, while the ink tank 60 is raised up by the eccentric cam 68 to decrease the liquid level difference, the negative pressure applied to the ink is controlled so as to be lower than during printing. At this time, it is preferable that the target negative pressure value for controlling the internal pressure of the print head 50 be set to −0.5 kPa.

Next, during non-discharge determination, power off, uncapping, or standby, the internal pressure of the sub-tank 64 is controlled so that the internal pressure of the print head 50 is lower than during printing. In other words, the ink tank 60 is lowered under the eccentric cam 68 to increase the liquid level difference, and the negative pressure applied to the ink is controlled so as to be higher than during printing. At this time, it is preferable that the target negative pressure value for controlling the internal pressure of the print head 50 be set to −2.5 kPa, similar to the previous example.

When the paper jams directly underneath the print head, the negative pressure is further controlled so as to be sufficiently higher than during printing. For example, the target value for the negative pressure is preferably about −10 kPa.

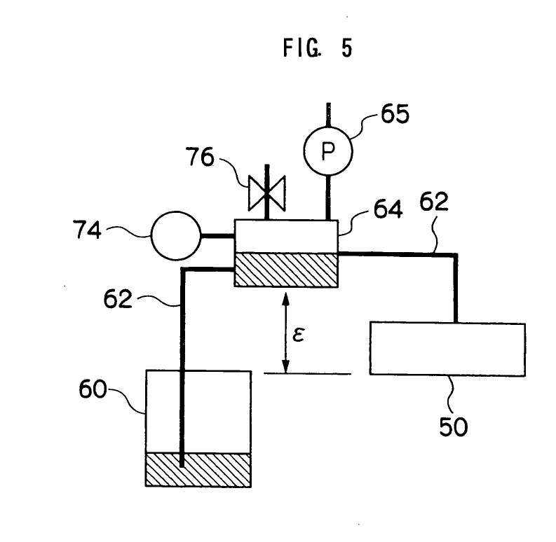

FIG. 5 is a general schematic drawing of the ink supply system in the inkjet recording apparatus according to the yet another embodiment of the present invention. The ink supply system shown in FIG. 5 is similar to the ink supply system in FIG. 3, except that the pressure gauge 66 that was installed near the print head 50 is now installed in the sub-tank 64.

In other words, instead of measuring the internal pressure of the print head 50 with the pressure gauge 66 installed near the print head 50 as in the embodiment in FIG. 3, the embodiment shown in FIG. 5 comprises a pressure gauge 74, which is installed in the sub-tank 64 and the internal pressure of the sub-tank 64 is measured.

In this case, the internal pressure of the sub-tank 64 is controlled by applying and suctioning out pressure by means of the pump 65 installed in the sub-tank 64, similar to the embodiment in FIG. 3. In addition, the sub-tank 64 is provided with an atmosphere venting valve 76 for resetting the internal pressure to atmospheric pressure.

Since the internal pressure of the sub-tank 64 is measured in this embodiment, the value measured by the pressure gauge 74 must be corrected according to the difference in elevation ε between the sub-tank 64 and the print head 50. However, since this embodiment is otherwise similar to the embodiment shown in FIG. 3 in terms of internal pressure control and the like, a detailed description is therefore omitted.

As described above, the inkjet recording apparatus 10 according to the embodiment of the present invention comprises a sub-tank 64 as a pressure varying device for varying the internal pressure of the print head 50, and has a plurality of target values for controlling the internal pressure of the print head 50, so that the internal pressure is controlled by varying the target value according to the usage conditions of the print head 50. In addition, the usage conditions of the print head 50 are defined as the following three usage conditions: (1) printing; (2) preliminary discharge or ink suction; and (3) non-discharge determination, power off, or standby. In this case, the internal pressure of the print head 50 may be controlled by set values corresponding to at least two of these three usage conditions. Therefore, it is possible to control the internal pressure with extreme precision, and a stable ink discharge can be ensured.

It should be understood, however, that there is no intention to limit the invention to the specific forms disclosed, but on the contrary, the invention is to cover all modifications, alternate constructions and equivalents falling within the spirit and scope of the invention as expressed in the appended claims.

1. An inkjet recording apparatus which forms an image on a recording medium, comprising:
an ink discharge head which discharges droplets of ink onto the recording medium: and
a pressure varying device which controls an internal pressure of the ink discharge head according to a plurality of set values associated with a plurality of usage conditions for the ink discharge head.

2. The inkjet recording apparatus as defined in claim 1, further comprising a pressure measuring device which measures the internal pressure of the ink discharge head.

3. The inkjet recording apparatus as defined in claim 1, further comprising:
an ink tank which supplies the ink to the ink discharge head;
an ink supply channel which connects the ink tank with the ink discharge head; and
a sub-tank which is provided to the ink supply channel,
wherein the pressure varying device controls an internal pressure of the sub-tank so as to control the internal pressure of the ink discharge head.

4. An inkjet recording apparatus which forms an image on a recording medium, comprising:
an ink discharge head which discharges droplets of ink onto the recording medium; and
a pressure varying device which controls an internal pressure of the ink discharge head according to set values associated with at least two of the following usage conditions,
(1) a printing condition;
(2) at least one of a preliminary discharge condition and an ink suction condition; and
(3) at least one of a non-discharge determination condition, a power off condition, and a standby condition.

5. The inkjet recording apparatus as defined in claim 4, further comprising a pressure measuring device which measures the internal pressure of the ink discharge head.

6. The inkjet recording apparatus as defined in claim 4, wherein the pressure varying device controls the internal pressure of the ink discharge head during the at least one of the preliminary discharge condition and the ink suction condition so as to be higher pressure than the internal pressure of the ink discharge head during the printing condition.

7. The inkjet recording apparatus as defined in claim 4, wherein the pressure varying device controls the internal pressure of the ink discharge head during the at least one of the non-discharge determination condition, the power off condition, and the standby condition so as to be lower pressure than the internal pressure of the ink discharge head during the printing condition.

8. The inkjet recording apparatus as defined in claim 4, further comprising:
an ink tank which supplies the ink to the ink discharge head;
an ink supply channel which connects the ink tank with the ink discharge head; and
a sub-tank which is provided to the ink supply channel,
wherein the pressure varying device controls an internal pressure of the sub-tank so as to control the internal pressure of the ink discharge head.
